(19) United States
(12) Patent Application Publication
(10) Pub. No.: US 2002/0010524 A1
(43) Pub. Date: Jan. 24, 2002

(54) Method and system for introducing a new material into a product design system

(76) Inventors: Yimin Jin, Glenmont, NY (US); Stephen Michael Cooper, Newburgh, IN (US); Frank Nunzio Liberti, Mt. Vernon, IN (US); James Edmond Gosselin, Pittsfield, MA (US); William Carlos Faria, Lynnfield, MA (US); Johannes H. G. M. Lohmeijer, Hoogerheide (NL)

Correspondence Address: Thomas M. Blasey, Esq., Hunton & Williams, Suite 1200, 1900 K Street, N.W., Washington, DC, 20006, US

(21) Appl. No.: 09/750,918

(22) Filed: Jan. 2, 2001

Related U.S. Application Data
(60) Provisional application No. 60/173,701, filed on Dec. 30, 1999.

(51) Int. Cl. G06F 17/60

(52) U.S. Cl. 700/106; 705/28

(57) ABSTRACT

A method and system for introducing a new material into a product design system wherein the system receives basic material use information from a requesting party and determines whether a new material introduction (NMI) is necessary for acquiring approval to use the material. If an NMI is required, the system receives details of the NMI and electronically notifies appropriate approval departments of the NMI. The various approval departments are simultaneously supplied with specific NMI information. Once the NMI information has been reviewed, the system receives approval determinations from the various departments. If approvals have been received from all departments, the requesting party is notified of the approval and a database of NMI's is updated to reflect the approved NMI. However, if the NMI is not approved by all departments, the requesting party is so notified and the NMI database is not updated.

### CROSS REFERENCE TO RELATED APPLICATIONS

This application claims the benefit of provisional patent application Ser. no. 60/173,701, filed Dec. 30, 1999, the disclosure of which is incorporated herein by reference.

### BACKGROUND OF THE INVENTION

The present invention relates generally to systems and methods for designing and manufacturing products in a supply chain. More particularly, the present invention relates to providing a comprehensive system for facilitating the introduction of new materials or new material uses into a product design system.

Conventionally, distributed global manufacturing and design companies have struggled to efficiently introduce new materials, products and/or designs into their design systems. Because of inherent differences in both site development and requirements, new material introduction processes generally evolve differently at each site, thereby requiring time consuming translation and searching across the different sites in order to avoid inconsistent or redundant determinations. Further, multiple considerations must be taken into account when determining whether to approve a request introduction. Such considerations include environmental health and safety concerns, material sourcing or vendor concerns, and overall quality concerns. Since determinations regarding the material introduction must be made at each of these levels, the merging of dissimilar systems and the physical documentation associated with each system further compounds the inefficiency in conventional introduction methods.

Therefore, there is a need in the art of product design systems to facilitate the introduction of new materials or new material uses into the system. There is a further need for a method and system for providing globalized, automated introduction of new materials across distributed locations.

### BRIEF SUMMARY OF THE INVENTION

The present invention overcomes the problems noted above, and provides additional advantages, by providing for a method and system for introducing a new material into a product design system. A computer program application receives basic material use information from a requesting party and facilitates a determination as to whether a new material introduction (NMI) is necessary for acquiring approval to use the material. If an NMI is required, the program receives details of the NMI and electronically notifies appropriate approval departments of the NMI. The various approval departments are simultaneously supplied with specific NMI information. Once the NMI information has been reviewed, the program receives approval determinations from the various departments. If approvals have been received from all required departments, the requesting party is notified of the approval and a database of NMI's is updated to reflect the approved NMI. Correspondingly, the code for the newly approved material and its specification are electronically transmitted to appropriate manufacturing systems throughout the world. However, if the NMI is not approved by all departments, the requesting party is so notified and the NMI database is not updated.

### BRIEF DESCRIPTION OF THE DRAWINGS

The present invention can be understood more completely by reading the following Detailed Description of exemplary embodiments, in conjunction with the accompanying drawings, in which:

FIG. 1 is a flow chart describing a new material introduction process;

FIG. 2 is a flow chart describing a preferred operation of step 102 set forth in FIG. 1;

FIG. 3 is a flow chart describing a NMI for research and development option;

FIG. 4 is a flow chart describing one preferred embodiment of the operation of step 106 set forth in FIG. 1;

FIG. 5 is a flow chart describing a second preferred embodiment of the operation of step 106 set forth in FIG. 1, particularly related to vendor/sourcing information;

FIG. 6 is a flow chart describing a method for notifying appropriate approval departments about the NMI; and

FIG. 7 is a flow chart describing one preferred embodiment of a method for determining vendor/sourcing approval.

### DETAILED DESCRIPTION OF THE INVENTION

The system and method of the present invention described below, are preferably implemented by an interactive computer software application incorporated within a computer-readable medium such as a hard disk drive, an optical medium such as a compact disk, or the like. Further, the medium may be available to a user either locally on a user's computer or remotely over a computer network, such as a local area network (LAN) or the Internet. The inventive computer software application is designed to receive a plurality of new material introduction information from a NMI requester. The application then facilitates previously approved NMI searching and multi-party review.

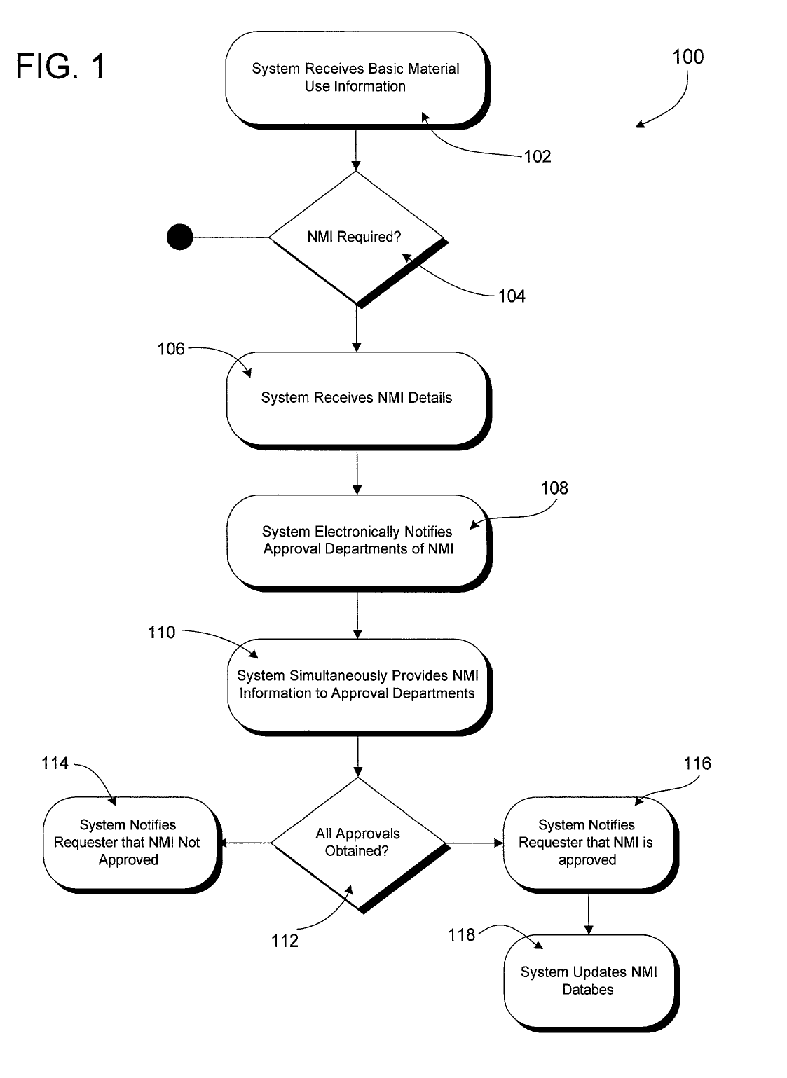

Referring to the Figures and, in particular, to FIG. 1, there is shown a flow chart describing a new material introduction (NMI) process, generally designated by the numeral 100. This introduction essentially ensures that the NMI has been approved for use on a variety of levels and further incorporates the NMI into an overall product line design system, thereby enabling subsequent searching and retrieval of the received information. Essentially NMI approval authorizes a material for use in one or more specific processes or products, at a specific site, at a specific building or group of buildings within the site (since different buildings may have different air and water regulations)—commonly referred to as a “plant”, with specific maximum loading, within a specific process or product, and from a specific supplier. Prior to approval on all fronts, a material may not be used in production. The inventive methods provides a comprehensive means for introducing the new material use into the design process, and obtaining the requisite authorizations.

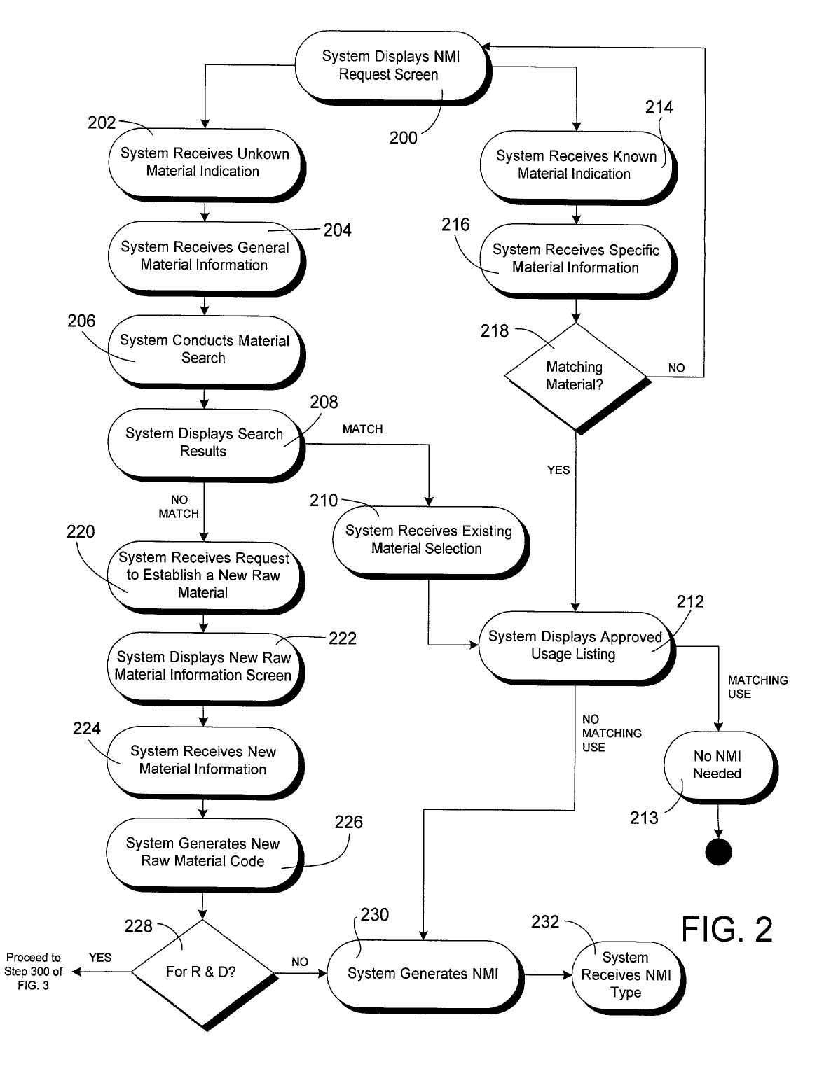

In step 102, the system receives basic material use information. In step 104, the system, based upon the material use information provided by the requester, facilitates a user determination as to whether a NMI program should be generated or not. That is, the inventive system may be initially used to investigate whether the material use has been previous approved. If so, no NMI program is required, since approval has already been obtained. However, if the material or material use in question is new, an new NMI program is initiated, wherein approval from various entities is required prior to implementation. Generally, NMI's are used to introduce a variety of different types of material information into a supply chain process. Although not limited thereto, in a preferred embodiment particularly directed to the industrial plastics/polymers industry, suitable types of material information include: new raw material/colorant information; new material sourcing information; new material use information; material tolling information; new internal resin information; new physical form information (e.g., powder, etc.); and indirect material/chemical information. Essentially requests for any new material, new use for an existing material, or new supplier for an existing material are received by the system for approval. A preferred operation of step 102 is set forth in additional detail in FIG. 2.

In step 200, the system displays an NMI request screen to the requester. Preferably, the NMI request screen includes options enabling the requester to indicate whether the NMI involves a known raw material or an unknown raw material. In step 202, the system receives an indication from the requester that the NMI involves an unknown raw material. The term “unknown” is meant to include materials for which a cataloged code, name, or number is not known to the requester, thereby modifying the manner in which the system searches for the particular material. In step 204, the system receives the general material information that is known, such as pertinent specifications, or a particular material category into which the material falls. Next, in step 206, the system, using the general information received in step 204, conducts a raw material search of a database of previously established raw materials. In step 208, the results of the search are displayed from the user including a listing of existing raw materials that match or closely match the requested material.

If an existing material meets the requester's requirements, the system, in step 210 receives a selection of a particular existing material from the requester. In response, the system, in step 212, displays an approved usage screen to the requester detailing the various plants and/or product lines for which the selected material has been approved. If, upon review, it is determined that the material has been previously approved for the new plant/product line combination (“PPC”), the requester recognizes that no NMI is needed and stops the NMI request process in step 213. However, if upon review of the approved plants/product lines, it is determined that the new use has not been previously approved, the requester proceeds to step 228 for a determination as to whether the NMI is for experimental or manufacturing use.

Returning back to step 200, if the requester knows the specific raw material he wants to use already exists within the system, the system receives, in step 214 an indication that the raw material is a known raw material. Next, in step 216, specific raw material information from the requester, such as a specific raw material code, etc. Upon receipt of this information, the system in step 218, upon user request, conducts a search of existing NMI information to determine whether the submitted information corresponds to an existing raw material. If the requester determines that the submitted information corresponds to an existing raw material, the system proceeds to step 212, described above, where a listing of approved plant/product line combinations (“PPC's”) for the raw material are displayed.

If, through the process described above, the requester determines that the raw material in question does not previously exist within the system, the system, receives, in step 220, a request to establish a new raw material profile associated with the new material. Upon receipt of this request, the system, in step 222, displays a new raw material information screen. Preferably, the new raw material information screen is configured to receive information related to the various characteristics of the particular material. In particular, the new raw material information includes a description of the material, the type of raw material, the requested plant/product line, the planned start and end dates, any known supervisors or other related personnel, and a material safety data sheet (MSDS) for the requested material. In step 224, the system receives the new material information submitted by the user. Upon receipt of the new material information, the system, in step 226, generates a new material code and stores the code and material information for subsequent retrieval.

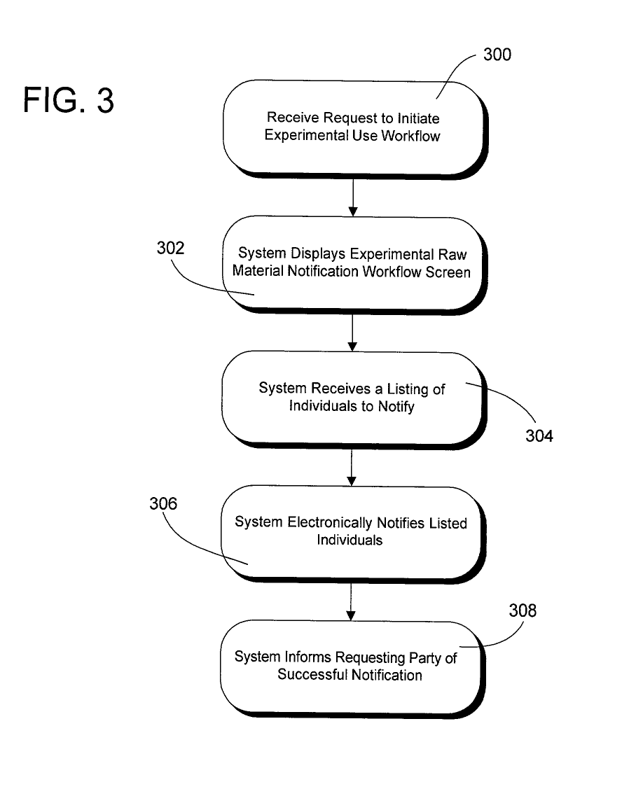

Once the new material has been coded or retrieved, the system, in step 228, receives an indication from the user relating to whether the new material use is for research and development only (i.e., experimental and not commercial). If a research and development use is desired, the user initiates a experimental raw material notification workflow in step 300 of FIG. 3. In step 302, the system displays an experimental raw material notification workflow screen. In step 304, the system receives a listing of individuals who the project owner wishes to notify of the experimental use. These individuals may include a local hygienist, or similar individual. In step 306, the system electronically notifies the designated individuals of the raw material experimental use and, in step 308, the system informs the requesting party that the notification was successful and that the material may be used for experimental purposes.

In an alternative embodiment, it may be necessary to obtain a lower level of approval prior to using a raw material for experimental purposes. In these circumstances, the system would require that additional information relating to health and safety of the material be input in accordance with an experimental use approval workflow. Following entry of the additional information, the system would require identification of appropriate approvers. The system would then electronically notify the designated approvers of the experimental raw material and the system would further require approval from these individuals prior to granting authorization to proceed to subsequent manufacturing approval stages use the material in production.

If a research and development use is not indicated, the system proceeds to step 230, where a full manufacturing use NMI program is generated. Following NMI program generation, the system receives an indication from the user regarding what type of NMI is being requested in step 232. As described briefly above, NMI's are instituted for various reasons such as completely new raw materials, material supplier changes, use translations for existing materials, etc. A selection of a particular NMI type determines the scope of the NMI and determines from whom approvals are required prior to material implementation in a manufacturing environment.

Once it has been determined that a NMI is required and the scope of the NMI has been ascertained, the system proceeds to step 106, where the system interacts with the user to receive specific information and additional details regarding the particular NMI. This information preferably relates to three distinct areas: 1) environmental health and safety (EHS); 2) vendor/sourcing; and 3) quality. Generally speaking, EHS refers to the safety concerns related to the use of a particular material for a particular use or location; vendor/sourcing refers to vendor specific information such as vendor name, capacity and contact information; and quality relates to the quality of the suggested material/PPC combination based upon similar specifications, the supplier's work practices, etc.

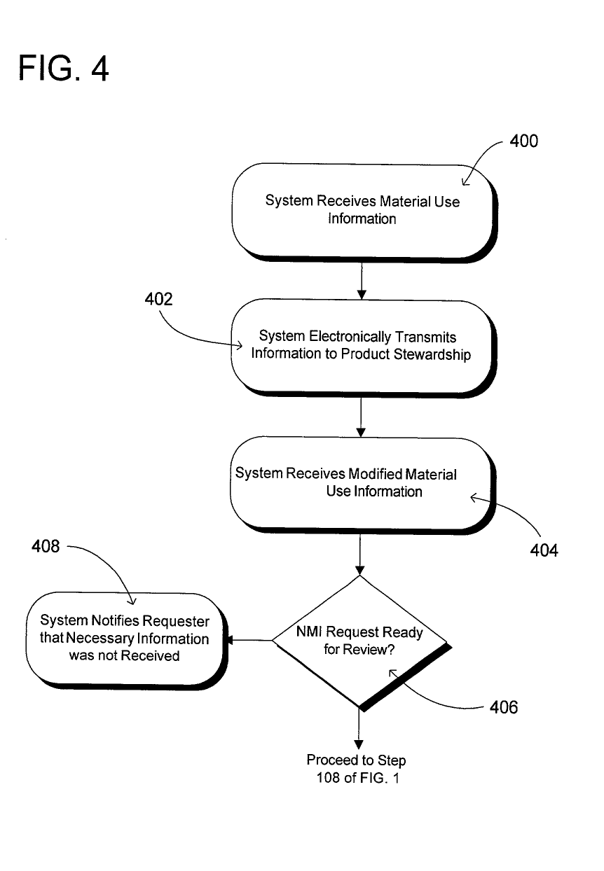

Referring now to FIG. 4, there is shown a flow chart describing one preferred embodiment of the operation of step 106 set forth above, particularly addressed to receiving EHS-related information. In step 400, the system receives material use information from the user related to the particular material and the intended use of the material. Upon receipt of the information, the system, in step 402, electronically transmits the received information to a product stewardship entity for review and a determination of completeness, composition, and compliance. In step 404, the system receives modified material use information, if available, from the product stewardship entity. The modified material use information remedies defects in the information provided by the NMI requester. At this point, the system determines, in step 406, whether the NMI request is ready for review. If the system is not ready for the approval process, the system, in step 408, notifies the requester that required information was either not obtained from the product stewardship entity in step 404 or not properly received from the requester in step 400. If however, the system determines that the NMI request is ready for the approval process, the system proceeds to step 108 of FIG. 1, wherein EHS, Vendor/Sourcing, and Quality are electronically notified of the NMI for approval.

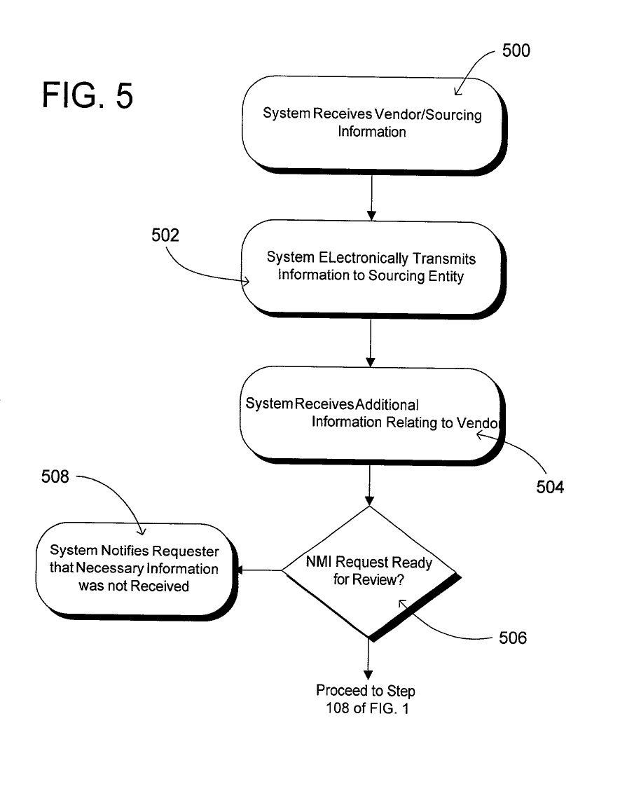

Referring now to FIG. 5, there is shown a flow chart describing a second preferred embodiment of the operation of step 106 set forth above, particularly addressed to receiving vendor/sourcing-related information. In step 500, the system receives vendor/sourcing information related to the proposed supplier for the particular material. Preferably, this information includes contact information as well as the supplier's identification for the material. Upon receipt of the vendor/sourcing information, the system, in step 502, electronically transmits the received information to a sourcing entity for review and a determination of completeness, composition, and compliance. In step 504, the system receives additional information from the sourcing entity relating to the selected vendor. At this point, the system determines, in step 506, whether the NMI request is ready for review. If the system is not ready for the approval process, the system, in step 508, notifies the requester that required information was either not obtained from the sourcing entity in step 504 or not properly received from the requester in step 500. If however, the system determines that the NMI request is ready for the approval process, the system proceeds to step 108 of FIG. 1, wherein EHS, Vendor/Sourcing, and Quality are electronically notified of the NMI for approval.

Returning now to FIG. 1, upon receipt of the various material information set forth in FIGS. 4 and 5, the system, in step 107, determines whether all required/mandatory information relating to the NMI has been received. If not, the system returns to step 106 where the additional necessary information is received. However, if all required information has been received, the system proceeds to step 108, where the system electronically notifies the selected approval department about the NMI. That is, an EHS approval department is notified about the EHS-related information received in accordance with FIG. 4, a vendor/sourcing approval department is notified about the vendor/sourcing-related information received in accordance with FIG. 5, and a quality approval department is notified about the quality-related information received in step 106. Further, based upon the information received by the system in FIGS. 4 and 5, the requester determines which entities to notify regarding the NMI. In other words, information such as type of NMI, site location, etc. are used to determine who approves the NMI for use. In this manner, independent approval determinations are made regarding each of the distinct NMI components. The results of the various approval determinations may then be shared with interested individuals across the system.

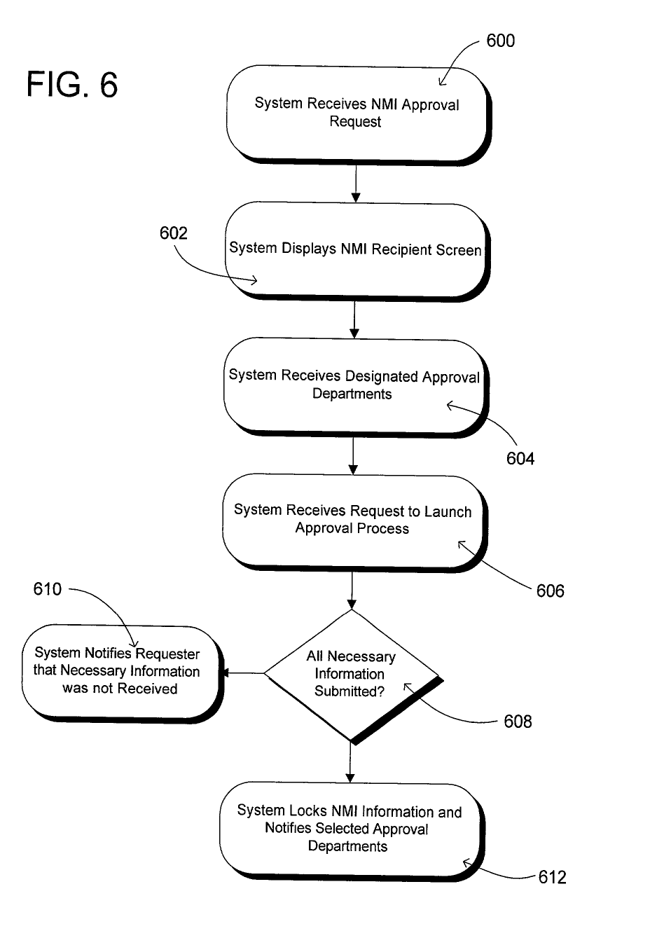

Referring now to FIG. 6, there is shown a flow chart describing the process of notifying the appropriate approval departments about the NMI as described in step 108 above. In step 600, the system receives a request from the requester to initiate the NMI approval process. Upon receipt of this request, the system, in step 602, displays a NMI recipient screen to the requester preferably including a menu driven interface for receiving information relating to the type of NMI, the location, and the product line. It is then up to the requester to select whom shall receive the NMI approval request. The designated approval departments or individuals are received by the system in step 604. In step 606, the system receives a user request to launch the NMI approval process and electronically notify the listed departments of the NMI. Preferably, the system conducts, in step 608, a final check of required NMI information. If all any required information is not present, the system, in step 610, interrupts the notification process and generates an appropriate error message to the requester. However, if all required information is present, the system in step 612 locks the NMI information from subsequent modification and electronically notifies the listed approval departments about the NMI.

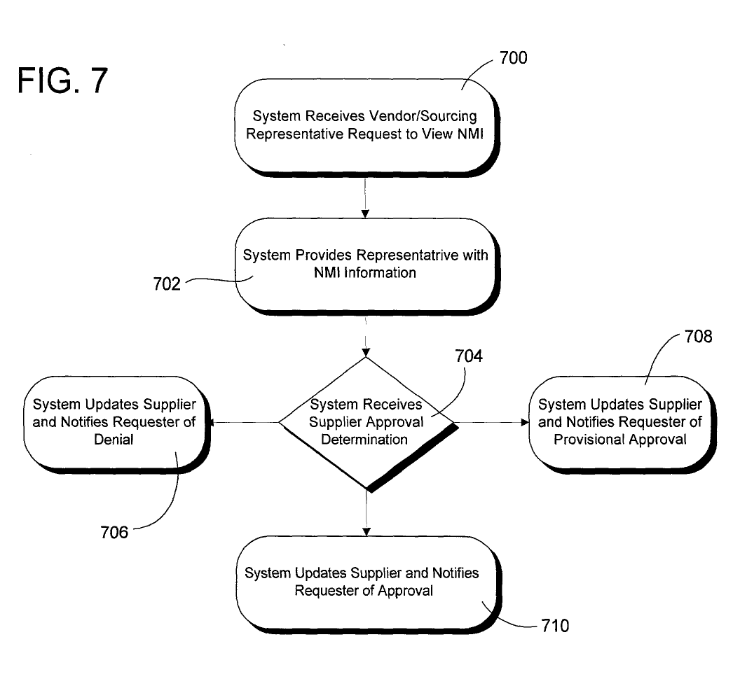

Referring back to FIG. 1, once notice of the NMI has been transmitted to the various approval departments, preferably by electronic mail or the like, the system, in step 110, provides NMI information to the various departments in parallel and receives approval determinations from each of the selected departments. FIG. 7 is a flow chart describing one preferred embodiment of a method for determining vendor/sourcing approval in accordance with step 110, described above.

In step 700, the system receives a vendor/sourcing representative's request to review the NMI. Upon receipt of this request, the system, in step 702, provides the vendor/sourcing representative with the various available pieces of NMI information related to vendor/sourcing approval as well as additional vendor/sourcing information such as the supplier's EHS information, etc. After review of this information the system, in step 704, receives an supplier approval determination from the vendor/sourcing representative. If the representative denies approval of the supplier, the system, in step 706, updates the supplier accordingly and notifies the requester of the status. If the vendor/sourcing representative provisionally approves the supplier pending a test period or additional information, the system, in step 708, updates the status accordingly and notifies the requester of the provisional approval. If the vendor/sourcing representative non-provisionally approves supplier, the system, in step 710, updates the status accordingly and notifies the requester of the non-provisional approval of the supplier.

It should be understood that the additional approval departments proceed substantially in the manner set forth in FIG. 7 above, wherein relevant information is provided to them for NMI review and an approval determination is received and stored by the system.

Returning to FIG. 1, once approval determinations have been received from all selected departments, the system, in step 112, determines whether approvals have been obtained from all departments. If approvals have not been obtained from all departments, the system, in step 114, notifies the requester that the NMI has not been approved. However, if approval has been obtained from all departments, the system, in step 116, notifies the requester that the NMI has been approved and that implementation of the material use may commence. Accordingly, in step 118, the system updates the NMI database to include the approved NMI for subsequent searching and review by future users.

By providing a comprehensive system for searching and requesting NMIs, the system of the present invention enhances the efficiency of the new material introduction process. In particular, by enabling the compilation and sharing of all relevant information, the entire NMI process is streamlined and usable by various organizations throughout the world.

While the foregoing description includes many details and specificities, it is to be understood that these have been included for purposes of explanation only, and are not to be interpreted as limitations of the present invention. Many modifications to the embodiments described above can be made without departing from the spirit and scope of the invention, as is intended to be encompassed by the following claims and their legal equivalents.

What is claimed is:

1. A method for introducing a new material into a product design system comprising the steps of:
receiving basic material use information from a requesting party;
electronically searching a database of stored new material introduction (NMI) information for NMI's matching the received basic material use information;
displaying a listing of NMI's matching the received basic material use information; and

2. The method of claim 1, further comprising the steps of:
receiving an indication from the requesting party that the new material is an unknown material;
receiving a plurality of general material information related to the new material;
electronically searching the database of stored NMI information for NMI's matching the received general material information; and
displaying a listing of NMI's matching the received basic material use information.

3. The method of claim 2, wherein the step of receiving a plurality of general material information further comprising the step of receiving known material specification information.

4. The method of claim 2, wherein the step of receiving a plurality of general material information further comprising the step of receiving known material category information.

5. The method of claim 1, further comprising the steps of:
receiving an indication from the requesting party that the new material is a known material;
receiving a plurality of specific material information;
electronically searching the database of stored NMI information for NMI's matching the received specific material information; and
displaying a listing of NMI's matching the received specific material use information.

6. The method of claim 5, wherein the step of receiving a plurality of specific material information further comprising the step of receiving known raw material code information.

7. The method of claim 1, further comprising the steps of:
receiving a selection of a particular NMI from the displayed listing of NMI's displaying a listing of approved uses for the selected particular NMI; and
determining whether a NMI program is necessary for acquiring approval to use the material based upon the displayed listing of approved uses for the selected particular NMI.

8. The method of claim 1, further comprising the steps of:
receiving a request from the requesting party to open a new NMI program;
receiving details relating to the new material;
electronically notifying a plurality of approval departments about the NMI, wherein the electronic notification takes place substantially simultaneously;
electronically supplying the plurality of approval departments with the details relating to the new material provided by the requesting party;
receiving approval determinations from the plurality of approval departments;
if said approval determinations from all of said plurality of approval departments indicate approval of the NMI, conducting the further step of notifying the requesting party of the approval of the NMI; and
if the approval determinations from any of the plurality of approval departments indicates a rejection of the NMI, conducting the further step of notifying the requesting party of the rejection of the NMI.

9. The method of claim 8, further comprising the step of updating the database of stored NMI information to include the NMI.

10. The method of claim 8, wherein the step of receiving details related to the new material further comprises the steps of:
receiving information related to environmental health and safety;
electronically notifying an environmental heath and safety department about the NMI;
electronically supplying the environmental heath and safety department with the details relating to the new material provided by the requesting party; and
receiving an approval determination from the environmental heath and safety department.

11. The method of claim 8, wherein the step of receiving new material details related to the new material further comprises the steps of:
receiving information related to material vendor/sourcing;
electronically notifying an vendor/sourcing department about the NMI;
electronically supplying the vendor/sourcing department with the details relating to the new material provided by the requesting party;
receiving an approval determination from the vendor/sourcing department.

12. The method of claim 8, wherein the step of receiving new material details related to the new material further comprises the steps of:
receiving information related to material quality;
electronically notifying a quality department about the NMI;
electronically supplying the quality department with the details relating to the new material provided by the requesting party;
receiving an approval determination from the quality department.

13. The method of claim 8, further comprising the steps of:
electronically notifying a product stewardship entity about the NMI;
supplying the product stewardship entity with the details related to the new material provided by the requesting party;
receiving a determination from the product stewardship entity regarding the compliance of the details to pre-established requirements;
conducting the step of electronically notifying a plurality of approval departments about the NMI if it is determined that the details are compliant; and
conducting the step of notifying the requesting party of non-compliance of the details if it determined that the details are determined to be compliant.

14. The method of claim 8, further comprising the steps of:
determining whether all required details related to the new material have been received from the requesting party; and
electronically notifying the requesting party if it is determined that all required details have not been received.

15. The method of claim 1, further comprising the steps of:
determining whether the new material is to be used for experimental or manufacturing purposes;
if it is determined that the new material is to be used for experimental purposes, conducting the steps of:
receiving, from the requesting party, a listing of individuals to notify of the experimental use; and
electronically notifying the individuals of the experimental use.

16. The method of claim 15, further comprising the step of electronically notifying the requesting party of successful notification of the individuals.

17. A method for introducing a new material into a product design system comprising the steps of:
receiving a request from the requesting party to open a new NMI program;
receiving details relating to the new material;
electronically notifying a plurality of approval departments about the NMI, wherein the electronic notification takes place substantially simultaneously;
electronically supplying the plurality of approval departments with the details relating to the new material provided by the requesting party;
receiving approval determinations from the plurality of approval departments;
if said approval determinations from all of said plurality of approval departments indicate approval of the NMI, conducting the further step of notifying the requesting party of the approval of the NMI; and
if the approval determinations from any of the plurality of approval departments indicates a rejection of the NMI, conducting the further step of notifying the requesting party of the rejection of the NMI.

18. A computer readable medium incorporating instructions for facilitating introduction of a new material into a product design system, comprising:
one or more instructions for receiving basic material use information from a requesting party;
one or more instructions for electronically searching a database of stored new material introduction (NMI) information for NMI's matching the received basic material use information;
one or more instructions for displaying a listing of NMI's matching the received basic material use information; and
one or more instructions for determining whether a NMI program is necessary for acquiring approval to use the material based upon the displayed listing of NMI's.

19. The computer readable medium of claim 18, further comprising:
one or more instructions for receiving an indication from the requesting party that the new material is an unknown material;
one or more instructions for receiving a plurality of general material information related to the new material;
one or more instructions for electronically searching the database of stored NMI information for NMI's matching the received general material information; and
one or more instructions for displaying a listing of NMI's matching the received basic material use information.

20. The computer readable medium of claim 19, wherein the one or more instructions for receiving a plurality of general material information further comprise one or more instructions for receiving known material specification information.

21. The computer readable medium of claim 19, wherein the one or more instructions for receiving a plurality of general material information further comprise one or more instructions for receiving known material category information.

22. The computer readable medium of claim 18, further comprising:
one or more instructions for receiving an indication from the requesting party that the new material is a known material;
one or more instructions for receiving a plurality of specific material information;
one or more instructions for electronically searching the database of stored NMI information for NMI's matching the received specific material information; and
one or more instructions for displaying a listing of NMI's matching the received specific material use information.

23. The computer readable medium of claim 22, wherein the one or more instructions for receiving a plurality of specific material information further comprises one or more instructions for receiving known raw material code information.

24. The computer readable medium of claim 18, further comprising the steps of:
one or more instructions for receiving a selection of a particular NMI from the displayed listing of NMI's one or more instructions for displaying a listing of approved uses for the selected particular NMI; and
one or more instructions for determining whether a NMI program is necessary for acquiring approval to use the material based upon the displayed listing of approved uses for the selected particular NMI.

25. The computer readable medium of claim 18, further comprising:
one or more instructions for receiving a request from the requesting party to open a new NMI program;
one or more instructions for receiving details relating to the new material;
one or more instructions for electronically notifying a plurality of approval departments about the NMI, wherein the electronic notification takes place substantially simultaneously;
one or more instructions for electronically supplying the plurality of approval departments with the details relating to the new material provided by the requesting party;
one or more instructions for receiving approval determinations from the plurality of approval departments;
one or more instructions for notifying the requesting party of the approval of the NMI, if said approval determinations from all of said plurality of approval departments indicate approval of the NMI; and
one or more instructions for notifying the requesting party of the rejection of the NMI if the approval determinations from any of the plurality of approval departments indicates a rejection of the NMI.

26. The computer readable medium of claim 25, further comprising one or more instructions for updated the database of stored NMI information to include the NMI.

27. The computer readable medium of claim 25, wherein the one or more instructions for receiving details related to the new material further comprise:
one or more instructions for receiving information related to environmental health and safety;
one or more instructions for electronically notifying an environmental heath and safety department about the NMI;
one or more instructions for electronically supplying the environmental heath and safety department with the details relating to the new material provided by the requesting party; and
one or more instructions for receiving an approval determination from the environmental heath and safety department.

28. The computer readable medium of claim 25, wherein the one or more instructions for receiving new material details related to the new material further comprise:
one or more instructions for receiving information related to material vendor/sourcing;
one or more instructions for electronically notifying an vendor/sourcing department about the NMI;
one or more instructions for electronically supplying the vendor/sourcing department with the details relating to the new material provided by the requesting party; and
one or more instructions for receiving an approval determination from the vendor/sourcing department.

29. The computer readable medium of claim 25, wherein the one or more instructions for receiving new material details related to the new material further comprise:
one or more instructions for receiving information related to material quality;
one or more instructions for electronically notifying a quality department about the NMI;
one or more instructions for electronically supplying the quality department with the details relating to the new material provided by the requesting party; and
receiving an approval determination from the quality department.

30. The computer readable medium of claim 25, further comprising:
one or more instructions for electronically notifying a product stewardship entity about the NMI;
one or more instructions for supplying the product stewardship entity with the details related to the new material provided by the requesting party;
one or more instructions for receiving a determination from the product stewardship entity regarding the compliance of the details to pre-established requirements;
one or more instructions for electronically notifying a plurality of approval departments about the NMI if it is determined that the details are compliant; and
one or more instructions for notifying the requesting party of non-compliance of the details if it determined that the details are determined to be compliant.

31. The computer readable medium of claim 25, further comprising:
one or more instructions for determining whether all required details related to the new material have been received from the requesting party; and
one or more instructions for electronically notifying the requesting party if it is determined that all required details have not been received.

32. The computer readable medium of claim 18, further comprising:
one or more instructions for determining whether the new material is to be used for experimental or manufacturing purposes;
one or more instructions for receiving, from the requesting party, a listing of individuals to notify of the experimental use if it is determined that the new material is to be used for experimental purposes; and
one or more instructions for electronically notifying the individuals of the experimental use.

33. The computer readable medium of claim 32, further comprising one or more instructions for electronically notifying the requesting party of successful notification of the individuals.

34. A computer readable medium for introducing a new material into a product design system, comprising:
one or more instructions for receiving a request from the requesting party to open a new NMI program;
one or more instructions for receiving details relating to the new material;
one or more instructions for electronically notifying a plurality of approval departments about the NMI, wherein the electronic notification takes place substantially simultaneously;
one or more instructions for electronically supplying the plurality of approval departments with the details relating to the new material provided by the requesting party;
one or more instructions for receiving approval determinations from the plurality of approval departments;
one or more instructions for notifying the requesting party of the approval of the NMI if said approval determinations from all of said plurality of approval departments indicate approval of the NMI; and
one or more instructions for notifying the requesting party of the rejection of the NMI if the approval determinations from any of the plurality of approval departments indicates a rejection of the NMI.
